(19) United States
(12) Patent Application Publication
(10) Pub. No.: US 2023/0237928 A1
(43) Pub. Date: Jul. 27, 2023

(54) METHOD AND DEVICE FOR IMPROVING DYSARTHRIA

(71) Applicant: Haii Co, Ltd., Seoul (KR)

(72) Inventors: Tae-Jin Song, Seoul (KR); Yuyoung Kim, Yongin-si (KR); Minjung Kim, Yongin-si (KR); Sangkwon Lim, Guri-si (KR)

(21) Appl. No.: 17/961,656

(22) Filed: Oct. 7, 2022

(30) Foreign Application Priority Data
Jan. 24, 2022 (KR) 10-2022-0010219

(51) Int. Cl. G09B 19/06; G10L 15/22; G10L 25/90; G10L 25/78

(52) U.S. Cl. CPC G09B 19/06; G10L 15/22; G10L 25/78; G10L 25/90; G10L 2015/225; G10L 2025/783

(57) ABSTRACT

A method of providing a language training to a user by a computing device comprising a processor and a memory is provided. The method comprises: providing contents corresponding to the language training to a user terminal; receiving the user’s voice data from the user terminal; detecting a pitch and a loudness of the user’s voice by analyzing the voice data; and generating a training evaluation by evaluating the user’s training for the contents corresponding to the language training based on the user’s voice data, further comprising determining a phoneme with poor pronunciation accuracy by analyzing the user’s voice data; and automatically generating and providing at least one of a vocabulary, a sentence, and a paragraph including the determined phoneme.

### FIELD OF THE INVENTION

The present disclosure relates to an apparatus and method for improving dysarthria and more specifically it relates to an apparatus and method for improving dysarthria that provides training to a person with dysarthria and display the visualized voice resulting from the training by receiving such voice.

### BACKGROUD OF THE INVENTION

In order to improve dysarthria caused by various causes such as brain damage, speech therapy is currently performed by a human based on logopedics. Speech therapies performed by humans is performed 2-3 times a week and evaluations of them can vary depending on the therapist, as a human performs it.

The present invention can add a game element so that a person with a dysarthria can perform training more focused. The present invention visualizes and shows the voice of a user with dysarthria in real time, so that the user can confirm his/her articulation in real time.

The present disclosure adds a game element to a training so that a person with dysarthria can perform the training whilst being more focused. The present disclosure visualizes and shows a voice of a user with dysarthria in real time, so that the user can confirm his/her articulation in real time.

### Prior Disclosures

(Patent Document 1) Korean Patent Publication No. 10-2021-0051278
(Patent Document 2) Korean Patent Publication No. 10-2015-0124561
(Patent Document 3) Korean Patent Publication No. 10-2008-0136624
(Patent Document 4) Korean Patent Publication No. 10-2016-0033450
(Patent Document 5) Korean Patent Publication No. 10-2019-0051598
(Patent Document 6) Korean Patent Publication No. 10-2019-0158038
(Patent Document 7) Korean Patent Publication No. 10-2020-0010980
(Patent Document 8) Korean Patent Publication No. 10-2020-0081579
(Patent Document 9) Korean Patent Publication No. 10-2020-0102005

### SUMMARY OF THE INVENTION

According to one aspect of the present disclosure, a method of providing a language training to a user by a computing device comprising a processor and a memory, the method comprises, providing contents corresponding to the language training to a user terminal; receiving the user’s voice data from the user terminal; detecting a pitch and loudness of the user’s voice by analyzing the voice data; and generating a training evaluation by evaluating the user’s training for the contents corresponding to the language training based on the user’s voice data, further comprising determining a phoneme with poor pronunciation accuracy by analyzing the user’s voice data; and automatically generating and providing at least one of a vocabulary, a sentence, and a paragraph including the determined phoneme.

In one embodiment of the present disclosure, a method further comprises, after the detecting a pitch and a loudness of the user’s voice, measuring the user’s language level based on the detected user’s pitch and loudness; generating feedback in real time based on the measured language level of the user; updating contents representing the feedback corresponding to the language training; and transmitting the updated content in which the feedback appears to the user terminal in real time, so that the user can check the feedback in real time.

In one embodiment of the present disclosure, the contents corresponding to the language training is an image that includes an agent and an object, wherein the agent includes a first image, and the object includes a second image different from the first image; the generating a feedback includes generating the feedback so that the agent moves toward the object or moves away from the object in response to the detected loudness of the user’s voice.

In one embodiment of the present disclosure, the generating feedback includes generating a feedback where the agent moves towards a first direction facing the object in response to determining that the loudness of the detected user’s voice is greater than or equal to a selected threshold and the agent moves towards a second direction opposite to the first direction in response to determining the loudness of the detected user’s voice is less than the selected threshold.

In one embodiment of the present disclosure, the generating feedback includes removing the object overlapping with the agent from the contents in response to the agent overlapping with the object by moving towards the first direction.

In one embodiment of the present disclosure, the contents corresponding to the language training is an image that includes an agent and an object, wherein the agent includes a first image, and the object includes a second image different from the first image; and the generating of the feedback includes generating the feedback so that the agent moves in an upward or downward direction of the object in response to the pitch of the detected user’s voice.

In one embodiment of the present disclosure, the generating feedback includes generating a feedback where the agent moves towards the upward direction relative to the object in response to determining that the pitch of the detected user’s voice is greater than or equal to a selected threshold and moves towards the downward direction relative to the object in response to determining the loudness of the detected user’s voice is less than the selected threshold.

In one embodiment of the present disclosure, the contents corresponding to the language training is an image that includes an agent and an object, wherein the agent includes a first image, and the object includes a second and a third image different from the first image. The second image represents a first pitch and placed on a first position of the contents and the third image represents a second pitch different from the first pitch and placed on a second position of the contents that is different from the first position. The generating feedback includes placing the agent in line with the second image or the third image in response to the pitch of the detected user’s voice.

In one embodiment of the present disclosure, the contents corresponding to the language training may include a vocabulary of at least two syllables and an image of a human neck structure, and further comprises, after receiving the user’s voice data from the user terminal, determining whether the syllables of the user’s voice data corresponds to a syllable of the vocabulary of at least two syllables and changing the neck structure image in response to the correspondence between the user’s voice data and the syllables of the vocabulary of at least two-syllables.

In one embodiment of the present disclosure, the analyzing of the voice data to detect the pitch and loudness of the user’s voice includes obtaining a decibel value of the user’s voice and the measuring the user’s language level based on the detected user’s pitch and loudness. The measuring the user’s language level based on the detected user’s pitch and loudness includes acquiring at least one of the user’s sound length, beat accuracy, and breath holding time based on the decibel value.

In one embodiment of the present disclosure, the measuring the user’s language level based on the detected user’s pitch and loudness includes determining whether the pitch is maintained at a level greater than or equal to a threshold for a selected time based on the pitch.

In one embodiment of the present disclosure, the contents corresponding to the language training includes a sentence; and further comprises, after the receiving the user’s voice data from the user terminal, evaluating a pronunciation accuracy of the user by analyzing the voice data.

In one embodiment of the present disclosure, the evaluating a pronunciation accuracy of the user by analyzing the voice data includes measuring a pronunciation accuracy by converting voice data into a text and comparing it to a sentence included in contents corresponding to the language training and measuring a pronunciation accuracy through Deep learning.

In one embodiment of the present disclosure includes, after the providing the contents corresponding to the language training to the user terminal, receiving the user’s face image data from the user terminal, and detecting at least one of a user’s lip shape, cheek shape, and tongue movement by analyzing the face image data.

In one embodiment of the present disclosure, the contents corresponding to the language training includes contents for training the user’s breathing, vocalization, modulation, resonance, and prosody.

In one embodiment of the present disclosure includes, after detecting the pitch and loudness of the user’s voice, generating a training evaluation by evaluating the user’s training for content corresponding to the language training based on the user’s voice data, storing the training evaluation in the memory; and determining the language training to provide to the user based on the training evaluation

In one embodiment of the present disclosure, the generating the training evaluation by evaluating the user’s training includes analyzing the user’s voice data to determine a phoneme with poor pronunciation accuracy and automatically generating and providing at least one of a vocabulary, a sentence, and a paragraph including the determined phoneme.

The above methods of the present disclosure may be performed by a computing device comprising of a processor and a memory

According to another aspect of the present disclosure, a method of the present disclosure may be performed by a computing device comprising of a processor and a memory: including providing contents corresponding to the language training to a user terminal; receiving the user’s voice data and the pitch and decibels of the user’s voice collected based on a voice data from the user terminal; detecting a pitch and a loudness of the user’s voice by analyzing the voice data; and generating a training evaluation by evaluating the user’s training for the contents corresponding to the language training based on the user’s voice data, further comprising determining a phoneme with poor pronunciation accuracy by analyzing the user’s voice data and automatically generating and providing at least one of a vocabulary, a sentence, and a paragraph including the determined phoneme; and storing the training evaluation in the memory.

According to another aspect of the present disclosure, a method of which the computing device comprising a processor and a memory providing a language training to a user includes: providing first contents and second contents corresponding to the language training wherein the first contents including a first agent image and a first object image and the second contents including a second agent image and a second object image to a user terminal, wherein the first contents are configured such that the first agent image is movable in response to the pitch and loudness of the user’s voice; the second contents includes a first pitch image placed on a first position of the second contents, which represents a first pitch and a second pitch image that represents a second pitch and placed on a second position of the second contents different from the first position; and the second contents are configured such that the second agent image corresponds to the user’s pitch and is in line with the first pitch image or the second pitch image; receiving the user’s voice data; receiving a training evaluation of the user for each of the first contents and the second contents; preferentially providing any one of the first contents and the second contents to the user terminal based on the training evaluation; and storing the speech data and the training evaluation in the memory.

In one embodiment of the present disclosure includes providing third contents including at least one of a vocabulary, a sentence, and a paragraph to the user terminal; generating a training evaluation for the third content by analyzing the user’s voice data; and, based on the training evaluation for each of the first contents and the second contents and the training evaluation for the third contents, providing preferentially one of the first to third contents to the user terminal.

In one embodiment of the present disclosure, the generating a training evaluation for third contents includes determining a phoneme with poor pronunciation accuracy by analyzing the user’s voice data; and automatically generating at least one of a vocabulary, a sentence, and a paragraph that includes the determined phoneme.

Speech therapy can be performed as much as you want without time and space constraints. Personalized training can be provided. By visualizing and showing the voice of a user with dysarthria in real time, the training effect can be enhanced by allowing the user to check his or her articulation in real time.

### BRIEF DESCRIPTION OF THE DRAWINGS

FIG. 1 is a block diagram of a system for improving dysarthria according to an embodiment of the present disclosure.

FIG. 2 is a block diagram of an apparatus for providing a method for improving dysarthria according to an embodiment of the present disclosure.

FIG. 3 is a block diagram of an apparatus for providing a method for improving dysarthria according to an embodiment of the present disclosure.

FIG. 4 is a flowchart for providing a method for improving dysarthria according to an embodiment of the present disclosure.

FIGS. 5A to 5C are an example of a screen providing a non-verbal oral exercise according to an embodiment of the present disclosure.

FIGS. 6A to 6D are examples of screens for providing training and feedback according to an embodiment of the present disclosure.

FIGS. 7A to 7C are examples of screens for providing training and feedback according to an embodiment of the present disclosure.

FIGS. 8A to 8E are examples of screens for providing training and feedback according to an embodiment of the present disclosure.

FIGS. 9A to 9C are examples of screens for providing training and feedback according to an embodiment of the present disclosure.

FIGS. 10A and 10B are an example of a screen for providing training and feedback according to an embodiment of the present disclosure.

FIGS. 11A to 11C are examples of screens for providing training and feedback according to an embodiment of the present disclosure.

### DESCRIPTION OF THE INVENTION

Hereinafter, with reference to the accompanying drawings, the embodiments of the present disclosure will be described in detail so that those of ordinary skill in the art to which the present disclosure pertains can readily implement them. However, the present disclosure may be implemented in several different forms and is not limited to the embodiments described herein.

In order to clearly explain the present disclosure in the drawings, parts irrelevant to the description are omitted, and similar reference numerals are attached to similar parts throughout the specification.

Throughout the specification, when a part “includes” or “comprises” a certain component, it means that other components may be further included, rather than excluding other components, unless otherwise stated.

It is to be understood that the techniques described in the present disclosure are not intended to be limited to specific embodiments, and include various modifications, equivalents, and/or alternatives of the embodiments of the present disclosure.

The expression “configured to (or set to)” as used in this disclosure, depending on the context, can be used interchangeably with, for example, “suitable for”, “having the capacity to,” “designed to”, “adapted to”, “made to”, or “capable of”. The term “configured (or configured to)” is not necessarily means only “specifically designed to” hardware. Instead, in some circumstances, the expression “a device configured to” means that the device is “capable of” with other devices or components. For example, the phrases “a processor configured (or configured to perform) A, B, and C,” “a module configured (or configured to perform) A, B, and C”, means a dedicated processor (for example, it may mean an embedded processor) or a generic-purpose processor (e.g., a CPU or an application processor) capable of performing corresponding operations by executing one or more software programs stored in a memory device.

The prior disclosures described in the present disclosure are incorporated herein by reference in their entirety, and it will be understood that the contents described in the prior disclosures is applied to the portions briefly described in the present disclosure by a person of ordinary skill in the art.

Hereinafter, a method and device for improving dysarthria according to an embodiment of the present disclosure will be described with reference to the drawings.

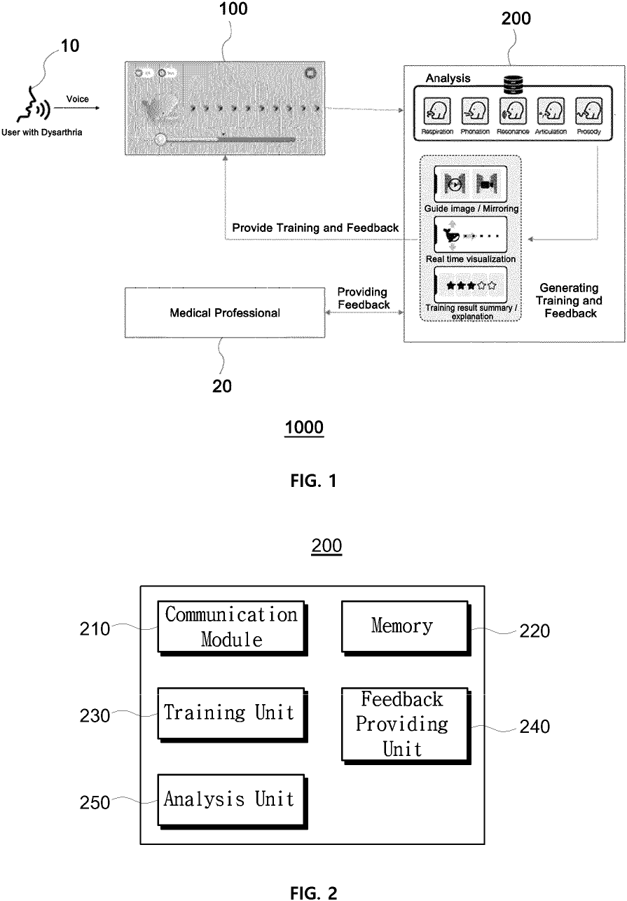

FIG. 1 is a block diagram of a system 1000 for improving dysarthria according to an embodiment of the present disclosure.

Referring to FIG. 1, a system 1000 includes a terminal device 100 and a server 200. The terminal 100 may receive the voice of the user 10 and transmit it to the server 200. The server 200 is configured to analyze the received voice of the user 10 and generate feedback to be provided to the user 10 based on the analysis. The server 200 may provide the generated feedback to the user 10. In addition, the server 200 may provide the generated feedback to a medical staff.

In one embodiment of the disclosure, the terminal 100 may receive and store the personal information of the user 10 or transmit it to the server 200. The server 200 may store personal information of the user 10. The personal information may include biographical information and medical information of the user. For example, the personal information may be at least one of real name, gender, age (date of birth), phone number, and dysarthria related medical information. The terminal 100 may provide a questionnaire to the user 10, receive an answer, and store it or transmit it to the server 200. The questionnaire provided by the terminal 100 to the user 10 may include a questionnaire received from the server 200.

The server 200 may generate training based on the answer to the questionnaire or may provide pre-stored training to the user 10 through the terminal 100. In one embodiment of the disclosure of the disclosure, the training may be training for training at least one of breathing, vocalization, articulation, resonance, and prosody. The training is visualized and provided to the user 10. The user 10 may perform training through the terminal 100 or by articulating in response to the training provided by the terminal 100. The articulation of the user 10 may be transmitted to the server 200 in the form of voice data. The training will be described in detail in later part of the disclosure.

The server 200 analyzes the voice data of the user 10 and obtain at least one of, for example, a loudness (decibel), a pitch, a pronunciation accuracy, a sound length, a pitch change, a breath hold, a beat, or a reading speed of the user 10. A method of analyzing the voice data of the user 10 will be described in detail in later part of the disclosure.

The server 200 may provide feedback to the user 10 by using the result of analyzing the user 10 ’s voice data. In one embodiment of the disclosure, the server 200 may provide feedback to the user 10 in real time. For example, the server 200 may provide the user 10 with visualization of the state of at least one of the user 10 ‘s loudness (decibel), pitch, pronunciation accuracy, sound length, pitch change, breath hold, beat, or reading speed in real time. Feedback provided by the server 200 to the user 10 will be described in detail in later part of the disclosure. The server 200 may measure the user’s language level based on the analysis result. The server 200 may provide feedback to the user based on the user’s language level.

In one embodiment of the disclosure of the disclosure, the language level may be determined differently according to the user’s pitch or the user’s loudness. For example, when the user’s sound level or sound level is within a selected range, the language level may be set to normal. When the user’s loudness or pitch does not belong to the selected range, the language level may be set to a non-normal value.

The server 200 may provide the user 10 ’s voice data analysis result to the medical staff 20. The medical staff 20 may provide the diagnosis or opinion of the medical staff 20 to the server 200 based on the voice data analysis result. The server 200 may generate feedback to be provided to the user based on the diagnosis or opinion of the medical staff 20. The server 200 may provide the user 10 with a diagnosis or opinion of the medical staff 20 or feedback generated based thereon.

Training to improve dysarthria can be performed by the user 10 performing dysarthria training by vocalizing or articulating according to the training provided through the terminal 100 and visualized feedback on training for dysarthria is checked and the user 10 ’s vocalizations, articulations, etc. are controlled, all in real time.

FIG. 2 is a block diagram of an apparatus for providing a method for improving dysarthria according to an embodiment of the present disclosure.

A device for providing a method for improving dysarthria may include a server 200. The server 200 includes a communication module 210, a memory 220, a training unit 230, a feedback providing unit 240, and an analysis unit 250.

The communication module 210 may be configured to receive an input of the user 10, such as vocalization and articulation of the user 10, and to provide training and feedback to the user 10 from the server 200. Information input by the user 10 into the terminal 100 (e.g., vocalization and articulation of the user 10, feedback, etc.) may be transmitted to the server 200 through the communication module 21. The communication module 210 may receive voice data such as the user 10 ’s vocalization and articulation in real time. The voice data received in real time may be analyzed by the analysis unit 250.

For example, the communication method of the communication module 210 may use a network constructed according to standards including GSM (Global System for Mobile communication), CDMA (Code Division Multi Access), HSDPA (High Speed Downlink Packet Access), HSUPA (High Speed Uplink Packet Access), LTE (Long) Term Evolution), LTE-A (Long Term Evolution-Advanced), etc.), WLAN (Wireless LAN), Wi-Fi (Wireless-Fidelity), Wi-Fi (Wireless Fidelity) Direct, DLNA (Digital Living Network Alliance), WiBro (Wireless Broadband), WiMAX (World Interoperability for Microwave Access), and 5G but is not limited thereto, and may include all transmission method standards to be developed in the future. It may include anything that can send and receive data through wired/wireless. Through the communication module 210, the script stored in the memory, visual information corresponding to the script, etc. may be updated.

The memory 220 is configured to store instructions that are executed by a processor (not shown). The memory 220 may be configured to store training, feedback, and analysis results provided by each of the training unit 230, the feedback providing unit 240, and the analysis unit 250.

In one embodiment of the disclosure, the memory 220 may include a computer-readable storage medium such as a data storage device that can be accessed by a computing device and provides persistent storage of data and executable instructions (e.g., software applications, programs, functions, etc.). Examples of the memory 220 include volatile and non-volatile memory, fixed and removable media devices, and any suitable memory device or electronic data store that maintains data for computing device access. The memory 220 may include various implementations of random-access memory (RAM), read-only memory (ROM), flash memory, and other types of storage media in various memory device configurations. The memory 220 may be configured to store executable software instructions (e.g., computer-executable instructions) executable with a processor or the same software application which may be implemented as a module.

In one embodiment of the disclosure, the training unit 230, the feedback providing unit 240, and the analysis unit 250 may be implemented by a processor and executable software instructions executable together with a processor stored in the memory 220. For example, the memory 220 may store instructions for performing the functions of the training unit 230, the feedback providing unit 240, and the analysis unit 250.

Training unit 230 may be configured to provide training to user 10. Training is an exercise to improve dysarthria, and may include at least one of non-verbal oral exercises, extended vocalization / loudness increase, pitch change training, resonance (velopharyngeal closure sound) training, syllable repetition training, and reading training. The training provided by the training unit 230 may be pre-stored in the memory 220.

In one embodiment of the disclosure, non-verbal oral exercises include exercises for strengthening the articulatory organs involved in speech production. For example, training for non-verbal oral exercise may provide an image guide for lip exercise, cheek-blowing exercise, and tongue exercise.

In one embodiment of the disclosure, the lip exercise may include a lip pulling exercise, a lip plucking exercise, and a lip pulling and plucking exercise. For example, a lip movement may include exercises to hold the lips in a “e” shape for 1 second, 2 seconds, 3 seconds, 4 seconds, 5 seconds, etc., hold the lips in a “o” shape for 1 second, 2 seconds, 3 seconds, 4 seconds, 5 seconds, etc., or repeating the lips between “e, o” shape 2 times, 3 times, 4 times, 5 times, etc. Ball inflating may include an exercise of inflating any one of both cheeks, the right cheek, and the left cheek, and maintaining it for a predetermined time, for example, 1 second, 2 seconds, 3 seconds, 4 seconds, 5 seconds, etc. The tongue exercise may include tongue sticking out, tongue raising, pushing the cheek with the tongue, moving the tongue side to side, moving the tongue following the shape of the lips, etc.

In one embodiment of the disclosure, the extended vocalization / loudness increase training includes extended vocalization, loudness reinforcement training for improving speech intelligibility. For example, the extended vocalization / loudness increase training may provide a suggested vocabulary and may provide training for the user 10 to follow the suggested vocabulary with a constant sound according to the target speech time and loudness.

In one embodiment of the disclosure, the suggested vocabulary may be provided in the form of a combination of a consonant and a vowel. For extended vocalization / loudness increase training, a target (e.g., loudness, vocalization time, etc.) may be set based on previous training contents. A goal may be provided to the user 10. Real-time analysis of extended vocalization / loudness increase training may be provided by the analysis unit 250 and the feedback providing unit 240 based on the user’s vocalization. The extended vocalization / loudness increase training may be training to identify the training result through the loudness, length, and pitch of the sound.

In one embodiment of the disclosure, the pitch change training includes training to improve the prosody and intelligibility of speech. The pitch-changing training includes a training that provides an increase in pitch, e.g., Do, Re, and Mi, or a descending pitch, e.g., Mi, Re, and Do, and training that verifies whether the user 10 changes the pitch in long and large manner. If the notes do not match, feedback can be provided to the user 10.

In one embodiment of the disclosure, the resonance training includes training to build the strength of the muscles that close the oropharynx (wind passage). For example, it includes a training that confirm that the user 10 makes a specific sound, e.g., “AK” with accurate pronunciation and hold a breath for a predetermined time, e.g., 1 second, 3 seconds, 5 seconds, 7 seconds, etc., while the back of the tongue is in contact with the uvula. This may be a training exercise for evaluating whether the user 10 makes a first sound and maintains the back of the tongue in a state in which the oropharynx is blocked with it for a certain period of time.

In one embodiment of the disclosure, the syllable repetition training may include training to loosen the muscles of the lips and tongue, improving modulation and intelligibility. For example, it includes training to repeat vocalizations of syllables made up of plosives, such as one, two, three, etc. syllables, in sync with a beat. For example, syllable repetition exercises can be provided at different rates. For example, the rate at which a syllable is presented may increase or decrease. The syllable repetition training may be a training to determine whether the suggested vocabulary is consistently pronounced. The syllable repetition training may be training to determine the loudness of the sound and whether it is repeated at a constant rate.

In one embodiment of the disclosure, the reading training may include training to improve speech intelligibility. For example, the reading training is a training in which a sentence or paragraph is provided, and the user 10 reads it in parts. This includes training in which sentences, paragraphs, etc. are presented to the user 10, and the user 10 reads it aloud several times in time in sync with the beat.

For vocabulary reading training, vocabularies of multiple syllables may be provided. A one-syllable vocabulary may be provided as a suggestive vocabulary with a beginning/final sound e.g., of Korean. A two- or three- syllable vocabulary may be provided as a suggestive vocabulary that includes a beginning, middle, and final sound e.g., of Korean. In this case, vocabularies due to phonological fluctuations may be excluded.

A detailed description of the training will be described later part of the disclosure in conjunction with the drawings.

The feedback providing unit 240 provides feedback to the user 10. In one embodiment of the disclosure, the feedback providing unit 240 may provide feedback to the user 10 in real time based on the analysis result of the voice data of the user 10 received in real time. Feedback may include a visualized image. The feedback may be configured to inform the user 10 whether the user 10 is performing well in the training. For example, the feedback may be an image or a text, configured to inform the user 10, comprising at least one of loudness, pitch, sound length, pitch change, breath holding time, time signature, reading speed, etc. of the user 10 ’s voice. A detailed description of the feedback is provided later part of the disclosure in conjunction with the drawings.

Analysis unit 250 is configured to analyze the voice data of the user 10 received by the server 200 in real time. The analysis unit 250 may measure a loudness (e.g., decibels) and a pitch (pitch) of the user 10 ’s voice based on the user 10 ’s voice data.

In one embodiment of the disclosure, the loudness of the user 10′s may be obtained using a signal-to-noise ratio (SNR). SNR refers to the ratio indicating how loud the voice is compared to the noise. A large SNR value means that the voice is larger than the noise, and 0 decibel can be construed that the voice and the noise are the same. For example, the intensity may be obtained using the root mean square (RMS) of the amplitude value in a part of the streaming voice. The SNR is calculated by 20*log to the intensity. And, according to the surrounding environment, a method of adding or subtracting a correction value to the SNR value is used to set the zero point. Since a method of obtaining the decibel magnitude using SNR is known in the prior art, further detailed description thereof will be omitted.

In one embodiment of the present disclosure, the pitch may be obtained through a change according to the frequency of the voice. For example, the frequency is calculated by obtaining the spectral data of an incoming voice. Spectral data can be obtained by converting speech data into a spectrogram. Spectrogram is an analysis method that is the basis of speech signal processing, which divides a continuously given speech signal into pieces of a certain length and then applies a Fourier transform to the pieces, and is a two-dimensional figure with its horizontal axis representing the time information of the piece and its vertical axis representing the size of the frequency component in decibel units. From the spectrogram, it is possible to obtain a pitch frequency indicating the height of a voice signal and a formant frequency in which frequency components are concentrated for each phoneme.

In order to reduce the leakage of the frequency band when sampling the spectral data, the Blackman-Harris type window of the Fast Fourier Transform (FFT) algorithm can be used. The frequency is obtained by normalizing the speech spectrum data. Normalizing includes obtaining maximum/minimum values of sampled data and selecting non-exciting values using a difference therebetween. Since this method is known in the prior art, further detailed description thereof will be omitted.

In one embodiment of the disclosure, the speech spectrum data may be analyzed using formants. Formant analysis can be used to measure pronunciation accuracy, similarity, and pitch change. Through formant analysis, specific frequencies for vowels and consonants can be known and can be used for evaluation with reference to them.

Analysis unit 250, based on the decibels and pitch, may obtain the user 10 ’s voice loudness, sound length, pitch change, breath hold, beat, etc. For example, based on the decibels, it is possible to acquire loudness, length of the sound, breath hold, beat, and change in the pitch based on the pitch of the user 10 ’s voice. In addition, the analysis unit 250 may be configured to obtain pronunciation accuracy using a Speech-to-Text or an artificial intelligence. In addition, the analysis unit 250 may obtain a reading speed of the user 10 by comparing the length of the suggested vocabulary or sentence spoken by the user 10 to a length of an exemplarily recorded suggested vocabulary and sentence.

In one embodiment of the disclosure, the analysis unit 250 may obtain the loudness, sound length, pitch, sound length, pitch change, pronunciation accuracy, breath holding time, beat accuracy, and reading speed using the following methods.

The loudness is obtained by checking whether the loudness is maintained greater than or equal to the threshold using the measured decibel value. The threshold for each step of training can be adjusted to ensure that the loudness is greater than or equal to the selected level. For example, it is evaluated by calculating the probability (%) of the number of times that the size is greater than or equal to the threshold by checking whether the size is greater than or equal to the threshold for a predetermined period of time for each training stage. It will be understood by those skilled in the art that the threshold is a selected value and can be set properly. The probability (%) of the number of times that the size is greater than or equal to the threshold can be used to determine the user’s language level. For example, if the probability is greater than or equal to the selected value, it can be construed that the user’s language level is normal or the goal of normal or training has been achieved.

Sound length can be evaluated using whether the sound is interrupted. For example, the sound length is obtained by using the measured decibel value and checking whether it is maintained at a level above the threshold for a certain period of time. The amount of time to be maintained for each step may vary. For example, it may be preset to step 1 (3 seconds), step 2 (5 seconds), step 3 (10 seconds), and step 4 (15 seconds). The analysis unit 250 may determine that there is a sound interruption when step 1, e.g., 3 seconds, is not maintained. If there is no sound interruption during step 1, the difficulty can be changed to step 2 in the next training. It will be understood that the time to be maintained at each step is optionally variable.

The pitch of a sound can be obtained by checking whether or not it occurs with a constant pitch. For example, the measured pitch value should be used to keep the pitch value within a threshold range. The pitch is evaluated by calculating the probability (%) of the number of times that it does not deviate from the threshold range by checking it a predetermined number of times during a predetermined time. Alternatively, the pitch can be obtained by checking that the measured pitch value and formant value are maintained for a time selected for each pitch, e.g., 1 second, 2 seconds, 3 seconds, 4 seconds. It can be evaluated by calculating the probability (%) of the number of times that the pitch value and the formant value for each pitch are maintained by checking them for a predetermined number of times during the selected time. Loudness measurement for resonance practice can be evaluated as a score when the decibel value is greater than or equal to the decibel value of a predetermined size using the average value of the decibel values measured when the first and second vocabularies of the suggested vocabulary are pronounced. For example, it can be evaluated by dividing the average decibel value into 0, not more than 20 dB, or 20, 35, 50, or 65 dB or more. The probability (%) of the number of times that the pitch value and the formant value for each pitch are maintained by checking them for a predetermined number of times during the selected time can be used to determine the user’s language level. For example, if the probability is greater than or equal to the selected value, it may be determined that the user’s language level is normal or that the goal of training has been achieved.

The sound length may be obtained based on whether the sound length is maintained for a certain period of time at a level greater than or equal to a threshold using the measured decibel value. Regarding each pitch, a selected amount of time greater than or equal to a threshold, e.g., 1 second, 2 seconds, 3 seconds, 4 seconds, and 5 seconds should be maintained. It is evaluated by calculating the probability (%) of the number of times that is maintained within the selected time, e.g., 1 second, 2 seconds, 3 seconds, 4 seconds, and 5 seconds. The probability of the maintained number of times can be used to determine the language level of the user. For example, if the probability is greater than or equal to the selected value, it may be determined that the user’s language level is normal or that the goal of training has been achieved.

Pronunciation accuracy is evaluated according to the accuracy by pronouncing a plurality of vocabularies (each consisting of a plurality of syllables). For example, 3 vocabularies (6 syllables) are pronounced and evaluated according to their accuracy. The pronunciation is evaluated according to a number of correct number of syllables out of 1 syllable, 2 syllables, 3 syllables, 4 syllables, 5 syllables or more. It is possible to check for the correct syllable by comparing the suggest vocabulary to formants. The number of correct answers can be used to determine the user’s language level. For example, when the number of correct answers is equal to or greater than a selected value, it may be determined that the user’s language level is normal or that the target of training has been achieved.

The breath hold time is evaluated by checking a case in which the decibel value measured between the pronunciation of the first vocabulary of the presented vocabulary and the pronunciation of the second vocabulary after the selected time, for example, 1 second, 2 seconds, 3 seconds, 4 seconds, 5 seconds, 6 seconds, 7 seconds, 8 seconds, 9 seconds, 10 seconds is greater than or equal to a threshold. It is evaluated by calculating the average of the number of suggested vocabularies by checking the case in which the breath holding time for which the magnitude less than the threshold is measured is longer than or equal to the selected time, for example 0, 1, 2, 3, 4, 5 seconds. For example, if 10 suggested vocabularies were practiced and the second vocabulary was pronounced 4 times in decibels greater than or equal to the threshold after the selected time, the training can be evaluated as 4 out of 5 points. The score can be used to determine the user’s language level. For example, if the score is greater than or equal to the selected value, it may be determined that the user’s language level is normal or that the goal of training has been achieved.

In one embodiment of the disclosure, the analysis of sentence and vocabulary reading training may be as follows. One example is to perform text similarity measurement (cosine similarity algorithm, Ravenstein’s distance algorithm, etc.) by comparing a speech file with the original text after text conversion (STT) using speech recognition, and another example is to use a recorded voice file to measure the pronunciation accuracy using Deep learning and includes a method of collecting data of correct and incorrect pronunciations of vocabularies, sentences, and paragraphs presented in exercises, and using each of the data for modeling then learned by Deep learning to measure the pronunciation accuracy.

Reading speed can be analyzed by comparing the total length of the recorded voice with the length of the presentation voice used for training.

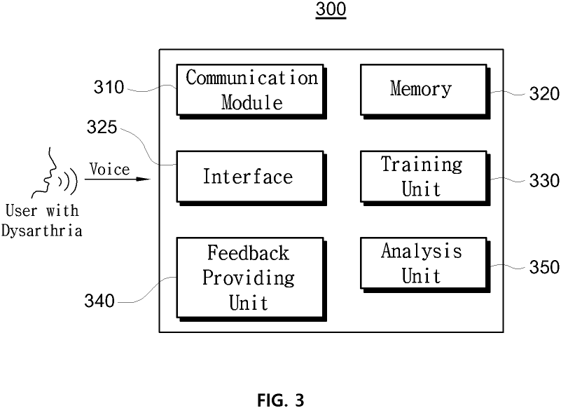

FIG. 3 is a block diagram of an apparatus 300 that provides a method for improving dysarthria according to an embodiment of the present disclosure.

Referring to FIG. 3, an apparatus 300 for providing a method for improving dysarthria may include a portable device such as a mobile phone, a tablet, or a laptop. That is, instead of transmitting voice data to the server 200 and analyzing the voice data in the server 200 and providing feedback back to the apparatus 300, the device 300 can analyze the voice data in the device 300 and provides feedback.

The apparatus 300 may include a communication module 310, a memory 320, an interface 325, a training unit 330, a feedback providing unit 340, and an analysis unit 350.

The communication module 310 is configured to be connected via wireless or wired to the apparatus 300 and an external device. The apparatus 300 may transmit information to or receive information from an external device (e.g., the server 200) through the communication module 310. In one embodiment of the disclosure, the information may be information to be provided to the medical staff 20 or information to be provided to the server 200, or information received from the medical staff 20 or information received from the server 200. The communication module 310 may be similar to or the same as the communication method of the communication module 210.

The memory 320, the training unit 330, the feedback providing unit 340, and the analysis unit 350 are substantially the same or similar to the memory 220, the training unit 230, the feedback providing unit 240, and the analysis unit 250, thus detailed descriptions thereof will be omitted.

Interface 325 is configured to receive voice information of the user 10, and provide training and feedback to the user 10. In one embodiment of the disclosure, the interface 325 may include at least one of all components that can communicate with the user 10, including a display, a touch screen, a microphone, a speaker, etc.

It will be understood by those of ordinary skill in the art that, in one embodiment of the disclosure, the function of a portion of at least any one of the memory 320, the training unit 330, the feedback unit 340, and the analysis unit 350 of the apparatus 300 can be implemented using the server 200′s memory 220, training unit 230, feedback unit 240, and analysis unit 250.

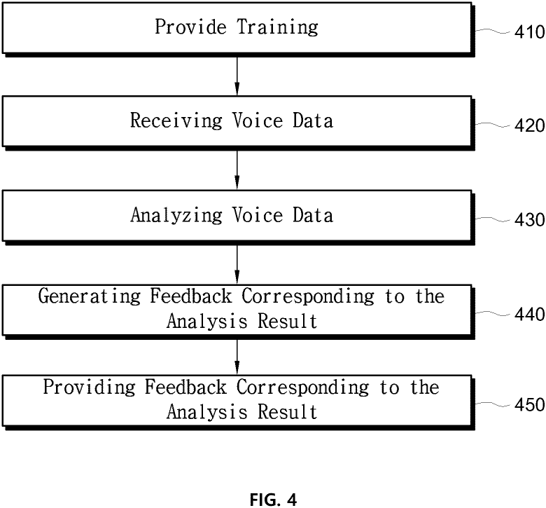

FIG. 4 is a flowchart for providing a method for improving dysarthria according to an embodiment of the present disclosure.

A method of providing a method for improving dysarthria may be provided to the user 10 through the terminal 100. In one embodiment of the disclosure, as shown in FIG. 1, the server 200 may provide training to the user 10 through the terminal 100. Then, the voice data of the user 10 corresponding to the training is transmitted to the server 200 through the terminal 100, and the server 200 can analyze the voice of the user 10 and provide feedback back to the terminal 100. Alternatively, like the apparatus 300 shown in FIG. 3, the apparatus 300 may analyze the voice data of the user 10 and provide training and feedback to the user 10. It will also be understood that receiving the voice data, providing training, analyzing the voice data, and generating and providing feedback may be performed on one or more devices and provided to the user 10. Hereinafter, it is assumed that the server 200 performs the method shown in FIG. 4.

In step 410, the server 200 provides training to the user 10. In one embodiment of the disclosure, the training unit 330 may provide training to the user 10, or a processor may be combined with the memory 320 to provide training to the user 10. The training is a training to improve dysarthria, and may include at least one of non-verbal oral exercise, extended vocalization / increase in loudness, pitch change training, resonance (oropharynx closure sound) training, syllable repetition training, and reading training.

In one embodiment of the disclosure, training may be provided based on the user 10 ’s existing training results. The status and existing training results of the user are stored in the memory 220 of the server 200. The training unit 230 may provide suitable training to the user 10 based on the state of the user 10 and an existing training result. For example, in the case of sound length training, the time to maintain the breath maintained for each stage is set differently, and the next stage of training can be provided after confirming that the previous stage has been passed. In the case of training including a plurality of steps, the training unit 230 may provide training of the next step after confirming that each step has been passed.

In response to the provided training, the user 10 generates sounds corresponding to voice data such as vocalization, articulation. In step 420, the server 200 receives the voice data of the user 10. The server 200 may receive the voice data of the user 10 through the communication module 210. The server 200 may receive voice data of the user 10 corresponding to the training in real time. In step 430, the analysis unit 350 analyzes the user’s voice data. In one embodiment of the disclosure, the analysis unit 250 may measure the loudness (e.g., decibels) and the pitch of the user 10 ’s voice based on the user 10 ’s voice data. The analysis unit 250 may acquire at least one of a loudness, a sound length, a pitch change, a breath hold, and a time signature of the user 10. The analysis unit 250 may obtain a loudness, a sound length, and a pitch for increasing the loudness of the extended vocalization. The analysis unit 250 may obtain a sound length and a pitch change for pitch change training. The analysis unit 250 may acquire pronunciation accuracy, breath holding time, and loudness for resonance practice. The analysis unit 250 may acquire pronunciation accuracy, beat accuracy, and loudness for syllable repetition practice. The analysis unit 250 may acquire pronunciation accuracy, reading speed, and loudness for training to read a vocabulary (e.g., 1, 2, 3 syllables). The analysis unit 250 may acquire pronunciation accuracy, reading speed, and loudness for training to read sentences and vocabulary with three or more word segments. The loudness, sound length, sound pitch, pitch change, pronunciation accuracy, breath holding time, beat accuracy, reading speed, etc. obtained by the analysis unit 250 are as described above, and thus detailed description thereof will be omitted.

In step 440, the feedback providing unit 240 generates feedback based on the voice data of the user 10 and the analysis result. The feedback may include a visualized image to inform the user 10 of the state of the user 10 ’s vocalization or articulation. Feedback may be provided based on the language level of the user 10. In step 450, the feedback providing unit 250 provides feedback to the user 10. The feedback providing unit 250 may provide feedback to the user 10 in real time. For example, the feedback providing unit 250 may be configured to maintain or notify the user 10 of a change in at least one of loudness, pitch, sound length, pitch change, pronunciation accuracy, breath holding time, beat accuracy, and reading speed of the user 10 ’s voice. Although not shown, the server 200 may store an analysis result of the voice data of the user 10. The analysis result may include a result performed by the user 10 in response to training. The analysis results may be referenced by the training unit 230 when providing the next training.

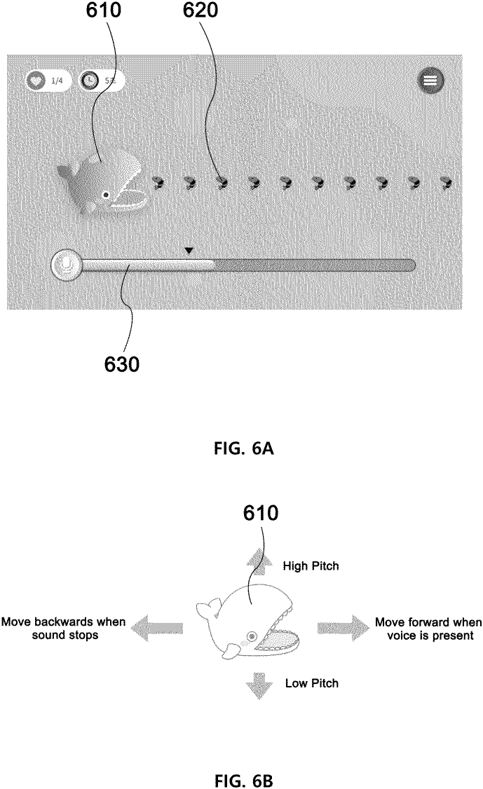

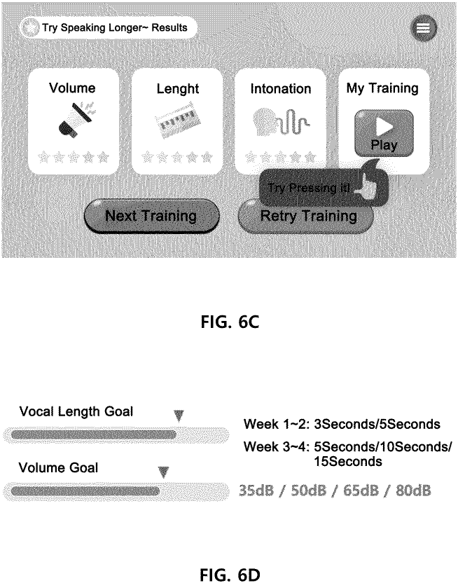

In one embodiment of the disclosure, the server 200 may be configured to correspond the user 10 ’s personal data with the user 10 ’s training content, analysis of the training, and feedback and store them on the memory 220. Accordingly, it is possible to provide personalized training, analysis, and feedback for each user 10. In one embodiment of disclosure, customized training may be provided by analyzing the part that the user 10 have deficiencies. For example, as a result of the analysis, training with a lower score or evaluation may be given as a top priority. The score or evaluation may be a score or evaluation that the user 10 inputs by oneself after each training, or it may be a score or evaluation evaluated by the server 200 according to a pre-stored criterion. For example, customized training may be provided based on the scores, or evaluations shown in FIGS. 6C, 7C, 8D, 9C, 10B, and 11C. In one embodiment of the disclosure, in response to determining that the pitch change is small, the pitch training may be continuously provided to reach a certain score (or evaluation), or the pitch training may be provided as a top priority at the start of the next training. In one embodiment of the disclosure, by analyzing the reading of the user 10, it is possible to identify a phoneme with poor pronunciation accuracy, and automatically generate and provide vocabularies, sentences, and paragraphs including the corresponding phoneme. For example, to patients whose accuracy and clarity of “T”, “D”, “N”, “S”, “Z” are poor, vocabularies, sentences, and paragraphs containing a lot of “T”, “D”, “N”, “S”, “Z” can be automatically generated and provided to the patients. If a user 10 is analyzed to have a problem with loudness, the treatment goal is adjusted so that the user can speak one step louder than the previous loudness by remembering the previous loudness. For example, it is possible to present a target decibel and store the result in the server 200 to provide a customized decibel or provide a next level of decibel. Training corresponding to the shortcomings can be provided by increasing the number of repetitions.

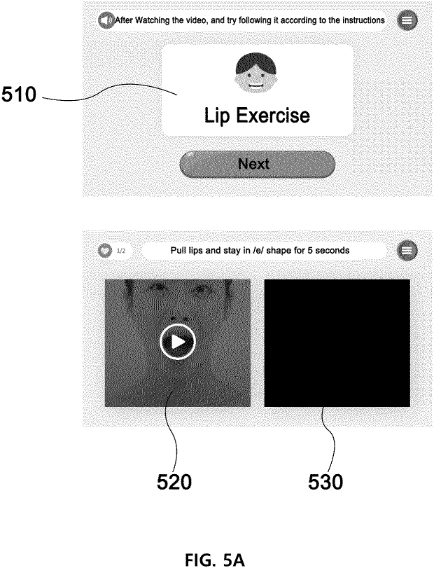

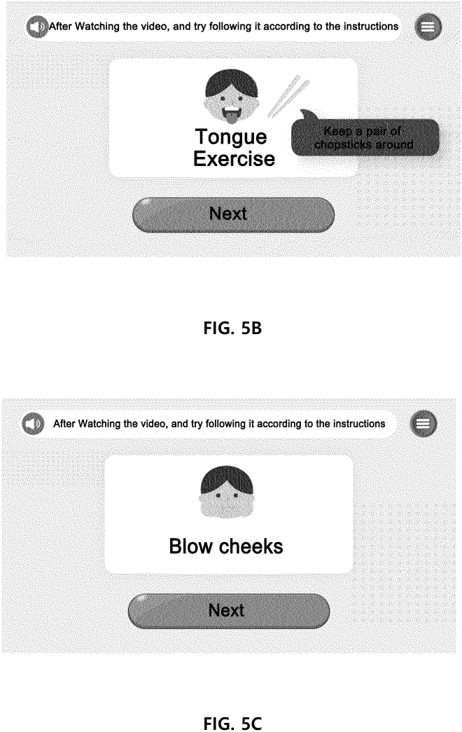

FIGS. 5A to 5C are an example of a screen providing a non-verbal oral exercise according to an embodiment of the present disclosure.

Referring to FIGS. 5A to 5C, the screen for providing non-verbal oral exercise includes a text 510 indicating what kind of training the currently provided training is, a guide image 520 for guiding the training, and a monitoring unit 530 for monitoring the face of the user 10. The text 510, the guide image 520, and the monitoring unit 530 may be displayed on one screen or displayed on another screen. In one embodiment of the disclosure, the guide image 520 and the monitoring unit 530 are displayed on the same screen, and the user 10 may monitor his/her training while following the guide image 520 through the guide image 520 and the monitoring unit 530.

FIGS. 6A to 6D are examples of screens for providing training and feedback according to an embodiment of the present disclosure. In one embodiment of the disclosure, FIG. 6A may be a training screen image for increasing extended vocalization sounds.

Referring to FIG. 6A, a screen for providing training and feedback may include an agent 610, an object 620, and a volume display 630. The agent 610 may move up, down, left, and right on the screen in response to the user 10 ’s voice. In one embodiment of the disclosure, the agent 610 may include images including an animal image (e.g., a terrestrial animal or a marine animal as a biota corresponding to plant), a plant image, and an anthropomorphic image. In FIG. 6A, the agent 610 is represented as a whale image, but it will be understood that the present invention is not limited thereto. At least one object 620 may be disposed on the screen. When the agent 610 is an animal, the object 620 may include an image of an animal that the animal can consume. In FIG. 6A, the object 620 is displayed as a shrimp image, but it will be understood that the present invention is not limited thereto. The object 620 may disappear from the screen when the agent 610 and the object 620 overlap as the agent 610 moves forward (e.g., on the right side of the screen). Accordingly, it may appear to be the agent 610 consuming the object 620. The volume display 630 may display an image indicating a target volume. The volume display 630 may display an image showing the volume of the user 10 ’s voice in real time.

FIG. 6B shows an example in which the agent 610 moves up, down, left, and right on the screen in response to the user 10 ’s voice. In one embodiment of the disclosure, the reference pitch may be based on the sound vocalized by the user at the start of training. For example, the location of the agent 610 and/or the object 620 may be determined based on the sound vocalized by the user during a selected period of time. The selected time can be set to, for example, 1 second, 2 seconds, 3 seconds, 4 seconds, 5 seconds, etc.

In one embodiment of the disclosure, at the time of the user 10 ’s vocalization, the agent 610 may advance (e.g., move towards the right side of the screen) in response to determining that the loudness is greater than or equal to a threshold. In response to determining that the loudness is less than the threshold, the agent 610 may move backward (e.g., move towards the left side of the screen). In response to determining that the sound level is greater than a threshold, the agent 610 may rise upwards on the screen, and the agent 610 may descend downward in response to determining that the sound level is less than a threshold. In one embodiment of the disclosure, at the time of the user 10 ’s vocalization, the agent 610 may move towards the object 620 in response to determining that the loudness is greater than or equal to a threshold. Here, the direction in which the agent 610 faces the object 620 may be referred to as a first direction. At the time of the user 10 ’s vocalization, the agent 610 may move in a direction opposite (or away from) the object 620 in response to determining that the loudness is less than the threshold. Here, a direction in which the agent 610 moves away from the object 620 or a direction opposite to the first direction may be referred to as a second direction. In response to determining that the pitch is greater than a threshold, the agent 610 rises to upward direction of the object 620, and in response to determining that the pitch is less than a threshold, the agent 610 descends in the downward direction of the object 620.

The method of measuring the loudness and pitch of the user 10’s voice has been described above, and detailed description thereof will be omitted. Accordingly, the server 200 can measure the loudness and pitch of the user 10′s voice in real time, and, by visualizing it based on the loudness and the pitch, provide feedback to the user 10 in real time through moving the agent 610.

Referring to FIG. 6C, feedback on training may be provided after training. The feedback on training may be input by the user 10 by himself or may be generated by comparing the user 10 ’s voice data with a criterion selected by the server 200.

Referring to FIG. 6D, the training screen may display a training target. In an embodiment of the disclosure, in the case of training for increasing the extended vocalization, a target of the duration of the extended vocalization and the loudness of the vocalization may be displayed on the screen. The loudness can be evaluated by calculating whether the measured decibel value maintains the loudness greater than or equal to the threshold, or the probability of the number of times that the loudness is greater than or equal to the threshold. The sound length can be evaluated according to whether the sound is maintained greater than or equal to the threshold for a certain period of time using the measured decibel value. For example, the time required to be maintained for each step may be different. The pitch can be evaluated by calculating whether the measured pitch value remains within a threshold range.

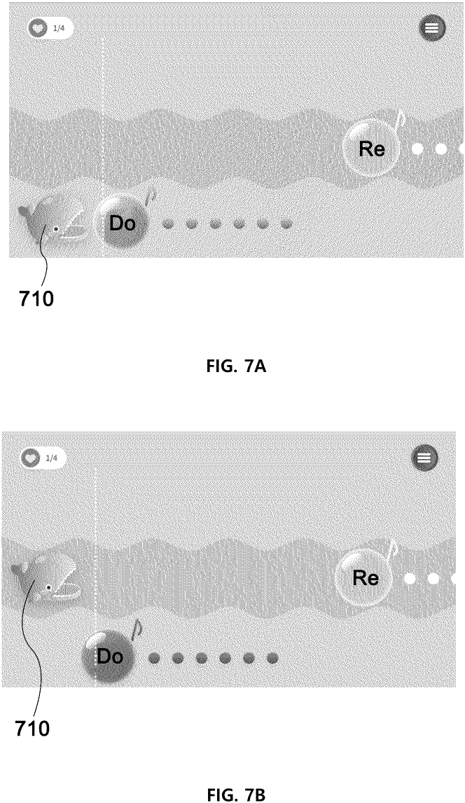

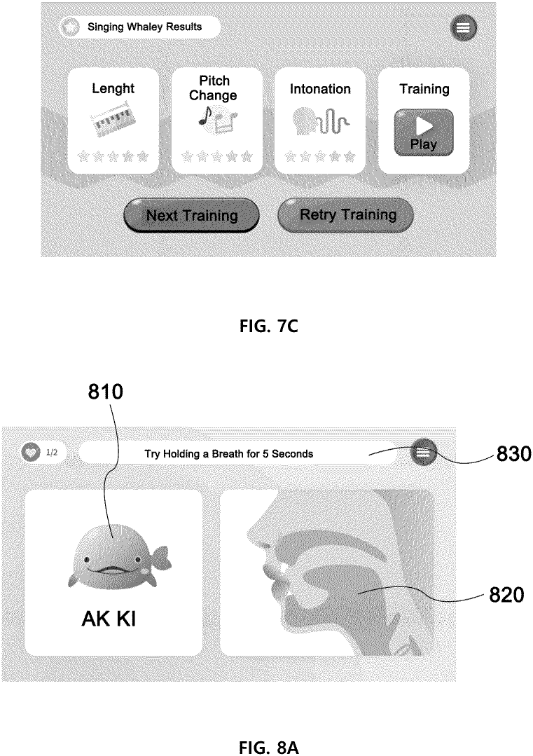

FIGS. 7A to 7C are examples of screens for providing training and feedback according to an embodiment of the present disclosure. In one embodiment of the disclosure, FIGS. 7A and 7B may be screen images for pitch training.

Referring to FIGS. 7A and 7B, the training screen may display the agent 710 and a scale. In one embodiment of the disclosure, the agent 710 may include an image including an animal (terrestrial animal, marine animal). In FIGS. 7A and 7B, the agent 710 is expressed as a whale image, but it will be understood that the present invention is not limited thereto. The agent 710 may move upward or downward on the screen in response to the pitch of the user 10 ’s voice, or may be stationary. For example, in response to determining that the pitch is greater than a selected scale, the agent 710 may rise in upwards direction of the screen, and in response to determining that the pitch is smaller than the selected scale, the agent 710 may descend toward the downward direction of the screen. If the pitch is the same as the selected scale or is within a certain error range, the agent 710 may not move up or down. Referring to FIG. 7B, it can be seen that the agent 710 is located higher than the “Do” scale displayed on the screen in response to the voice of the user 10. That is, in response to the user 10 vocalizing a pitch higher than “Do” pitch, it can be seen that the agent 710 is located at a higher place than the “Do” scale displayed on the screen in response to the user 10 ’s vocalization.

As described in FIGS. 7A and 7B, in one embodiment of the disclosure, the user 10 may be trained to maintain a “Do” pitch to keep the agent 710 collinear with “Do” and then maintain a “Re” pitch to keep it collinear with “Re”. In response to vocalizing the sound in accordance with the coming scale, the scale may change to a first color (e.g., blue). In response to not vocalizing a note in response to an oncoming note, the scale may change to a second color (e.g., red). The scale displayed on the screen can be modified in various ways, and the user 10 can perform vocal training to match the pitch displayed on the screen. The method of measuring the pitch of the user 10 ’s voice is described above, and a detailed description thereof will be omitted. In this way, the server 200 measures the loudness and pitch of the user 10 ’s voice in real time, visualizes it according to the size and pitch, and moves the agent 710 to provide feedback to the user 10 in real time.

Referring to FIG. 7C, feedback on training may be provided after training. Feedback on training may be an input by the user 10 by oneself or may be generated by comparing the user 10 ’s voice data to a criterion selected by the server 200. The loudness can be evaluated by calculating whether the measured decibel value maintains the loudness greater than or equal to the threshold, or the probability of the number of times that the loudness is greater than or equal to the threshold. The sound length can be evaluated according to whether the sound is maintained greater than or equal to the threshold for a certain period of time using the measured decibel value. The pitch can be evaluated by calculating whether the pitch value and the formant value are maintained for a predetermined period of time for each of the pitch.

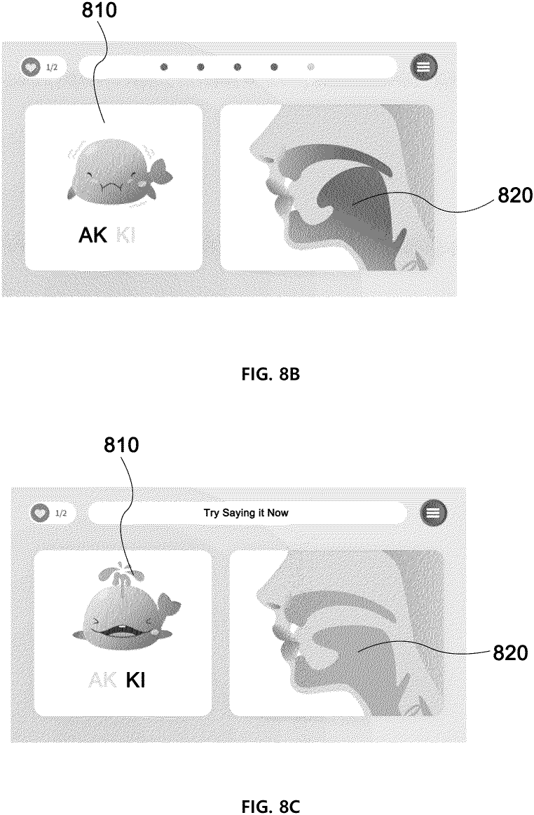

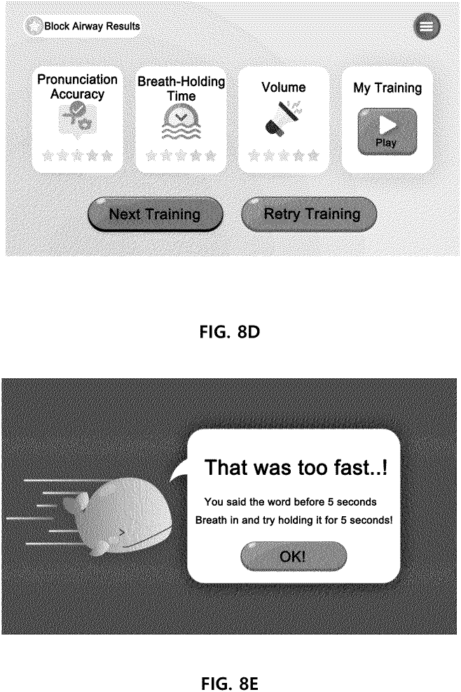

FIGS. 8A to 8E are examples of screens for providing training and feedback according to an embodiment of the present disclosure. In one embodiment of the disclosure, FIGS. 8A to 8C may be screen images for resonance (oropharynx closure sound) training.

Referring to FIGS. 8A to 8C, the training screen may include an agent image 810, a human neck structure image 820, and guide text 830. The agent image 810 may include an agent and an image of a vocabulary to be pronounced by the user 10. The vocabulary image may include a vocabulary of at least two syllables. Referring to 8A to 8C, an image of a vocabulary (i.e., “AK KI”, which is a Korean term for to “Instrument”) to be pronounced by the user 10 is provided on the agent screen 810, and a syllable to be pronounced by the user 10 is highlighted, and the agent is displayed differently correspondingly. For example, when the user 10 pronounces the first letter (i.e., “AK”), the agent changes into a state of holding a breath, and the neck structure image 820 also changes into a state in which the oropharynx is closed. While the user 10 is holding the breath, the agent changes to the image holding the breath, and if the user 10 makes a sound before the selected time, it can give feedback that it was too fast. After the selected time, when the user 10 pronounces the second letter (i.e., “KI”), the agent spits water, and the neck structure screen 820 may also change to a shape in which wind comes out through the oropharynx.

The human neck structure image 820 includes a visualized image for guiding the oropharyngeal closure, and the guide text 830 may provide the user 10 with a guide for training. The user 10 may perform training with reference to the agent image 810, the human neck structure image 820, and the guide text 830. In one embodiment of the disclosure, the vocabulary provided on the agent screen 810 may be a two-syllable vocabulary, and may consist of a vocabulary in which the back of the tongue touches the uvula of the user 10 when the first syllable is vocalized.

Referring to FIG. 8D, feedback on training may be provided after training. Feedback on training may be input by the user 10 by oneself or may be generated by comparing the user 10 ’s voice data with a criterion selected by the server 200. It can be evaluated by checking the case in which the decibel value measured between the pronunciation of the first vocabulary of the presented vocabulary and the pronunciation of the second vocabulary after, for example, 1 second, 2 seconds, 3 seconds, 4 seconds, 5 seconds is greater than or equal to a threshold. The average value of the decibel values measured when pronouncing the first and second syllables of the present vocabulary can be used to evaluate the score when it is greater than the decibel value of a predetermined size. Pronunciation accuracy can be evaluated by checking whether the syllable is correct by comparing the formants to the suggested vocabulary. Loudness can be evaluated by checking whether it is greater than the decibel value of a predetermined size using the average value of the decibel values measured when the first and second vocabularies are pronounced.

Referring to FIG. 8E, feedback on training may be provided after training. The feedback on training may be generated by comparing the criteria selected by the server 200 with the voice data of the user 10.

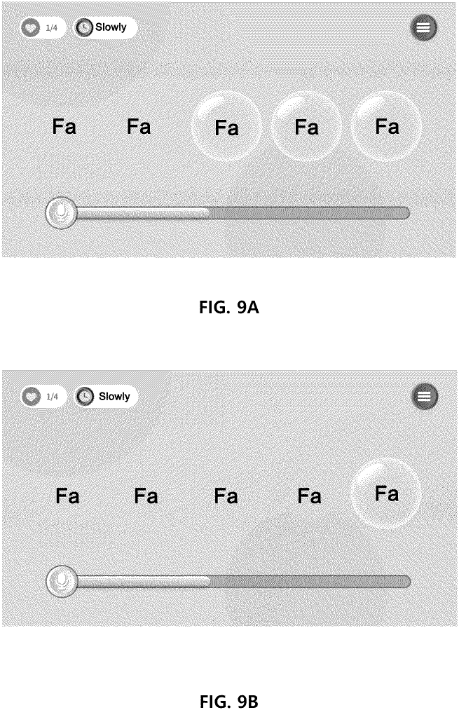

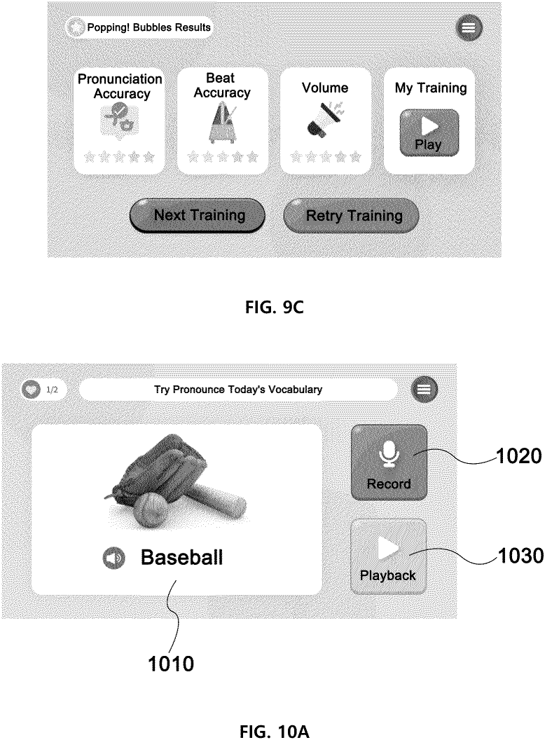

FIGS. 9A to 9C are examples of screens for providing training and feedback according to an embodiment of the present disclosure. In one embodiment of the disclosure, FIGS. 9A to 9C may be screen images for syllable repetition training.

Referring to FIGS. S. 9A and 9B, training is provided for the user 10 to pronounce the provided suggested vocabulary with correct pronunciation. The balloon surrounding the suggested vocabulary disappears corresponding to the user 10 ’s vocalization, and, depending on whether the user made the correct pronunciation 10 or not, the suggested vocabulary may be displayed in a different color. In one embodiment of the disclosure, the training may provide a suggested vocabulary that presents not less than one syllable, such as one syllable, two syllables, three syllables, etc.

Referring to FIG. 9C, feedback on training may be provided after the training. The feedback on training may be input by the user 10 by oneself or may be generated by comparing the user 10 ’s voice data with a criterion selected by the server 200.

FIGS. 10A and 10B are examples of screens for providing training and feedback according to an embodiment of the present disclosure. In one embodiment of the disclosure, FIGS. 10A and 10B may be images for training the user 10 to correctly pronounce a vocabulary.

Referring to FIG. 10A, the training screen may include a suggestion screen 1010, a record button 1020, and a playback button 1030. The suggestion screen may include vocabularies for pronunciation training of the user 10 and images depicting the vocabularies. The record button 1020 is a button for recording the user’s pronunciation at discretion of the user 10. The playback button 1030 is a button that plays back a recorded vocabulary to the user 10.

Referring to FIG. 10B, feedback on training may be provided after training. The feedback on training may be input by the user 10 by oneself or may be generated by comparing the user 10 ’s voice data with a criterion selected by the server 200.

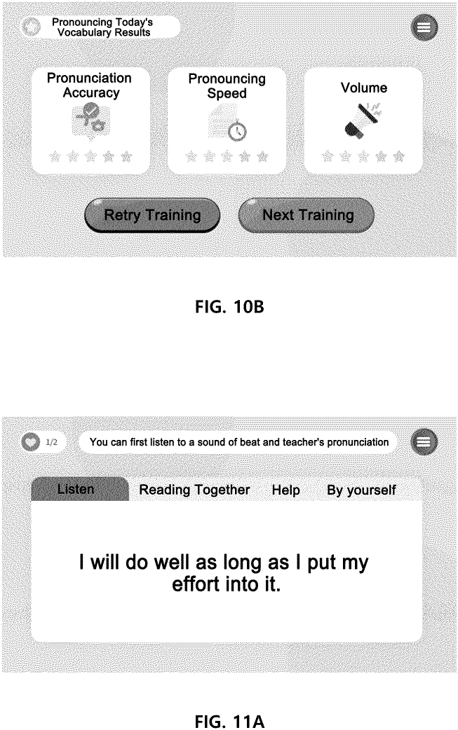

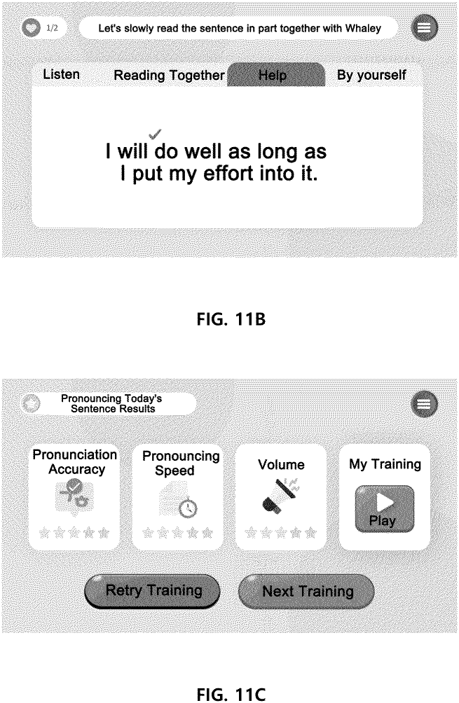

FIGS. 11A to 11C are examples of screens for providing training and feedback according to an embodiment of the present disclosure. In one embodiment of the disclosure, FIGS. 11A and 11B may be images that provide reading training to the user 10.

Referring to FIGS. 11A and 11B the training provides a sentence to the user 10 and provide several user modes including listening, reading together, getting help, and trying it alone. In the listening mode, the sentence to be practiced is played back to the user 10 in a pre-stored voice. In reading together mode, the user 10 vocalizes the sentence to be practiced together with the pre-stored voice. In getting help mode, the user 10 vocalizes the sentence to be practiced together with a guide sound. In the trying it alone mode, the user 10 vocalizes the sentence alone. In the trying it alone mode, the user’s voice may be automatically recorded.

Referring to FIG. 11C, feedback on training may be provided after training. The feedback on training may be input by the user 10 by oneself or may be generated by comparing the user 10 ’s voice data with a criterion selected by the server 200.

In one embodiment of the disclosure, the personal information of the user 10 and the training result of the user 10 may be stored in the server 200. Therefore, it is possible to provide customized training according to the previous training results for each user 10.

The apparatus and method described above may be implemented as a hardware component, a software component, and/or a combination of the hardware component and the software component. For example, devices and components described in the embodiments may be implemented using one or more general purpose computers or special purpose computers, for example, a processor, controller, arithmetic logic unit (ALU), digital signal processor, microcomputer, field programmable array (FPA), programmable logic unit (PLU), microprocessor, or a certain other device capable of executing and responding to instructions. The processing device may execute an operating system (OS) and one or more software applications running on the operating system. The processing device may also access, store, manipulate, process, and generate data in response to execution of the software. Although, for the convenience of understanding, there are instances where one processing device is described as being used, a person of ordinary skill in the art will recognize that a processing device may include a plurality of processing elements and/or a plurality of types of processing elements. For example, the processing device may include a plurality of processors or one processor and one controller. Other processing configurations are also possible, such as parallel processors.

Software may include a computer program, code, instructions, or a combination of one or more of these, and configure a processing unit to behave as desired, or independently or collectively give instructions to the processing unit. The software and/or data may be permanently or temporarily embodied on a certain machine, component, physical device, virtual equipment, computer storage medium or device, or transmitted signal wave in order to be interpreted by or to provide instructions or data to the processor. The software may be distributed over networked computer systems and stored or executed in a distributed manner. The software and data may be stored in one or more computer-readable recording media.

The described embodiments of the present disclosure also allow certain tasks to be performed on a distributing computing environment performed by remote processing devices that are linked through a communications network. In the distributed computing environment, program modules may be located in both local and remote memory storage devices.

As described above, although the embodiments have been described with reference to the limited drawings, those of ordinary skill in the art may apply various technical modifications and variations to the above, based on them. Appropriate results can be achieved when, for example, the described techniques are performed in an order different from the described method, and/or the described components of a system, structure, apparatus, circuit, etc. are combined or combined in a different form than the described method, or other components or an equivalent may be substituted or exchanged to achieve an appropriate result.

Therefore, other implementations, other embodiments, and equivalents to the claims are also within the scope of the following claims.

1. A method of providing a language training to a user by a computing device comprising a processor and a memory, the method comprising:
providing contents corresponding to the language training to a user terminal;
receiving the user’s voice data from the user terminal;
detecting a pitch and a loudness of the user’s voice by analyzing the voice data; and
generating a training evaluation by evaluating the user’s training for the contents corresponding to the language training based on the user’s voice data, further comprising determining a phoneme with poor pronunciation accuracy by analyzing the user’s voice data; and automatically generating and providing at least one of a vocabulary, a sentence, and a paragraph including the determined phoneme.

2. The method of claim 1 further comprising, after the detecting a pitch and a loudness of the user’s voice:
measuring the user’s language level based on the detected user’s pitch and loudness;
generating feedback in real time based on the measured language level of the user;
updating contents representing the feedback corresponding to the language training; and
transmitting the updated contents in which the feedback is represented to the user terminal in real time, so that the user can check the feedback in real time.

3. The method of claim 2, wherein the contents corresponding to the language training is an image that includes an agent and an object, wherein the agent includes a first image and the object includes a second image different from the first image; and
the generating feedback includes generating the feedback so that the agent moves toward the object or moves away from the object in response to the detected loudness of the user’s voice.

4. The method of claim 3, wherein the generating feedback includes generating a feedback where the agent moves towards a first direction facing the object in response to determining that the loudness of the detected user’s voice is greater than or equal to a selected threshold and the agent moves towards a second direction opposite to the first direction in response to determining the loudness of the detected user’s voice is less than the selected threshold.

5. The method of claim 4, wherein the generating feedback further comprises removing the object overlapping with the agent from the contents in response to the agent overlapping with the object by moving towards the first direction.

6. The method of claim 2, wherein the contents corresponding to the language training is an image that includes an agent and an object, wherein the agent includes a first image and the object includes a second image different from the first image;
and the generating feedback includes generating the feedback so that the agent moves in an upward or downward direction of the object in response to the pitch of the detected user’s voice.

7. The method of claim 6, wherein the generating feedback includes generating a feedback where the agent moves towards the upward direction relative to the object in response to determining that the pitch of the detected user’s voice is greater than or equal to a selected threshold and moves towards the downward direction relative to the object in response to determining that the pitch of the detected user’s voice is less than the selected threshold.

8. The method of claim 2, wherein the contents corresponding to the language training is an image that includes an agent and an object, wherein the agent includes a first image and the object includes a second image and a third image different from the first image, where the second image represents a first pitch and placed on a first position of the contents and the third image represents a second pitch different from the first pitch and placed on a second position of the contents that is different from the first position; and
the generating feedback includes placing the agent in line with the second image or the third image in response to the pitch of the detected user’s voice.

9. The method of claim 1, wherein the contents corresponding to the language training includes a vocabulary of at least two syllables and an image of a human neck structure, and further comprises after the receiving the user’s voice data from the user terminal:
determining whether the user’s voice data corresponds to a syllable of the vocabulary of at least two syllables; and
changing the neck structure image in response to the correspondence between the user’s voice data and the syllable of the vocabulary of at least two syllables.

10. The method of claim 2, wherein the detecting a pitch and a loudness of the user’s voice includes obtaining a decibel value of the user’s voice; and
the measuring the user’s language level includes acquiring at least one of the user’s sound length, beat accuracy, and breath holding time based on the decibel value.

11. The method of claim 2, wherein the measuring the user’s language level includes determining whether the pitch is maintained at a level greater than or equal to a threshold for a selected time based on the pitch.

12. The method of claim 1, wherein the contents corresponding to the language training includes a sentence;
and further comprises, after the receiving the user’s voice data from the user terminal, evaluating a pronunciation accuracy of the user by analyzing the voice data.

13. The method of claim 12, wherein the evaluating a pronunciation accuracy of the user includes: measuring text similarity by converting voice data into a text and comparing it to a sentence included in contents corresponding to the language training; and measuring a pronunciation accuracy through Deep learning.

14. The method of claim 1, further comprising, after the providing the contents corresponding to the language training to the user terminal:
receiving the user’s face image data from the user terminal; and
detecting at least one of a user’s lip shape, cheek shape, and tongue’s movement by analyzing the face image data.

15. The method of claim 1, wherein the contents corresponding to the language training includes contents for training the user’s breathing, vocalization, modulation, resonance, and prosody.

16. 16. A computing device for providing a language training to a user, the computing device comprising a processor and a memory, wherein the computing device is configured to
provide contents corresponding to the language training to a user terminal;
receive the user’s voice data from the user terminal;
detect a pitch and a loudness of the user’s voice by analyzing the voice data;
generate a training evaluation by evaluating the user’s training for the contents corresponding to the language training based on the user’s voice data;
determine a phoneme with poor pronunciation accuracy by analyzing the user’s voice data; and
automatically generate and provide at least one of a vocabulary, a sentence, and a paragraph including the determined phoneme.

17. A method of providing a language training to a user by a computing device comprising a processor and a memory, the method comprising:
providing contents corresponding to the language training to a user terminal;
receiving the user’s voice data and the pitch and decibels of the user’s voice collected based on a voice data from the user terminal;
detecting a pitch and a loudness of the user’s voice by analyzing the voice data; and
generating a training evaluation by evaluating the user’s training for the contents corresponding to the language training based on the user’s voice data, further comprising determining a phoneme with poor pronunciation accuracy by analyzing the user’s voice data and automatically generating and providing at least one of a vocabulary, a sentence, and a paragraph including the determined phoneme; and
storing the training evaluation in the memory.

18. A method of providing a language training to a user by a computing device comprising a processor and a memory, the method comprising:
providing first contents and second contents corresponding to the language training wherein the first contents including a first agent image and a first object image and the second contents including a second agent image and a second object image to a user terminal, wherein the first contents are configured such that the first agent image is movable in response to the pitch and loudness of the user’s voice; the second contents includes a first pitch image placed on a first position of the second contents, which represents a first pitch and a second pitch image that represents a second pitch and placed on a second position of the second contents different from the first position; and the second contents are configured such that the second agent image corresponds to the user’s pitch and is in line with the first pitch image or the second pitch image;
receiving the user’s voice data;
receiving a training evaluation of the user for each of the first contents and the second contents;
preferentially providing any one of the first contents and the second contents to the user terminal based on the training evaluation; and
storing the speech data and the training evaluation in the memory.

19. The method for providing a language training to a user of claim 18, further comprising:
providing third contents including at least one of a vocabulary, a sentence, and a paragraph to the user terminal;
generating a training evaluation for the third contents by analyzing the user’s voice data; and
based on the training evaluation for each of the first contents and the second contents and the training evaluation for the third contents, providing preferentially one of the first to third contents to the user terminal.

20. The method of claim 19, wherein the generating a training evaluation for third contents includes:
determining a phoneme with poor pronunciation accuracy by analyzing the user’s voice data; and
automatically generating at least one of a vocabulary, a sentence, and a paragraph that includes the determined phoneme.
